(19) United States
(12) Patent Application Publication
(10) Pub. No.: US 2010/0201679 A1
(43) Pub. Date: Aug. 12, 2010

(54) DRIVING CIRCUIT, DRIVING METHOD, ELECTRO-OPTICAL APPARATUS AND ELECTRONIC APPARATUS

(75) Inventor: Masahito YOSHII, Chitose-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/700,045

(22) Filed: Feb. 4, 2010

(30) Foreign Application Priority Data
Feb. 9, 2009 (JP) 2009-027475

(51) Int. Cl. G06F 3/038; G09G 3/20

(52) U.S. Cl. 345/214; 345/55

(57) ABSTRACT

Disclosed is a driving circuit that drives an electro-optical apparatus including electro-optical materials interposed between a pixel electrode and an opposite electrode which face each other, the driving circuit including an image signal supply unit that supplies the pixel electrode with an image signal corresponding to an image to be displayed, a common potential supply unit that supplies a common potential, which is a predetermined potential, to the opposite electrode, and a common potential control unit that, during a period for which the image signal is not supplied to the pixel electrode, controls the common potential supply unit such that the common potential is changed to a potential different from the predetermined potential and maintained for a predetermined period, and then the common potential is returned again to the predetermined potential.

### BACKGROUND

1. Technical Field

The present invention relates to a technical field of a driving circuit and a driving method that drive an electro-optical apparatus such as a liquid crystal apparatus, the electro-optical apparatus having the driving circuit, and an electronic apparatus, such as a liquid crystal projector, which has the electro-optical apparatus.

2. Related Art

An electro-optical apparatus driven by such a driving circuit, for example, controls electro-optical materials by generating an electric field between pixel electrodes and an opposite electrode, thereby displaying various images. In such an electro-optical apparatus, in detail, the electro-optical materials are controlled by a longitudinal electric field generated between the pixel electrodes and the opposite electrode, but display defects may occur due to a transverse electric field generated between adjacent pixels. In this regard, there has been proposed a technology of solving the above-described problem by temporarily changing a common potential supplied to the opposite electrode (for example, see JP-A-2005-208600).

However, according to the above-described technology, the common potential is changed in a pixel writing period (i.e., a period for which an image signal for displaying an image is supplied to the pixel electrodes), so that influence when the common potential is changed may appear in an image to be displayed. That is, according to the above-described technology, the common potential is changed, so that an intended image may not be displayed, causing degradation of image quality.

### SUMMARY

An advantage of some aspects of the invention is to provide a driving circuit, a driving method, an electro-optical apparatus, and an electronic apparatus, capable of displaying a high quality image.

According to one aspect of the invention, there is provided a driving circuit that drives an electro-optical apparatus including electro-optical materials interposed between a pixel electrode and an opposite electrode which face each other, the driving circuit including: an image signal supply unit that supplies an image signal, which corresponds to an image to be displayed, to the pixel electrode; a common potential supply unit that supplies a common potential, which is a predetermined potential, to the opposite electrode; and a common potential control unit that, during a period for which the image signal is not supplied to the pixel electrode, controls the common potential supply unit such that the common potential is changed to a potential different from the predetermined potential and maintained for a predetermined period, and then the common potential is returned again to the predetermined potential.

According to the driving circuit of the invention, when the driving circuit operates, the electro-optical materials such as liquid crystals are controlled by an electric field generated between the pixel electrode and the opposite electrode which face each other. In detail, image signals corresponding to an image to be displayed are respectively supplied to the pixel electrodes, which are provided corresponding to a plurality of pixels, from the image signal supply unit. Further, the common potential, which is the predetermined potential, is supplied to the opposite electrode, which is provided to face the pixel electrodes via the electro-optical materials, from the common potential supply unit. Consequently, the directions of molecules included in the electro-optical materials are respectively controlled by the difference between the potential (i.e., a pixel electrode potential) of the pixel electrodes having the image signals supplied thereto and the common potential, so that various images can be displayed in the electro-optical apparatus.

In the invention, in particular, the common potential control unit controls the common potential supply unit in the period (a so called blanking period) in which the image signals are not supplied to the pixel electrodes, so that the common potential is changed to a potential different from the predetermined potential and maintained for a predetermined period, and then the common potential is returned again to the predetermined potential. That is, the common potential is temporarily changed to the potential different from the predetermined potential in the blanking period. Further, in more detail, the “blanking period” is the period in which scanning lines are not selected, that is, the period in which scanning signals are not supplied to the scanning lines, and denotes the period in which the image signals are not supplied to any pixels.

The common potential is temporarily changed, so that the electric field between the pixel electrode and the opposite electrode can be changed, thereby effectively reducing display defects (so called domains) caused by a transverse electric field. That is, a voltage having a different value is temporarily applied to the electro-optical materials, which cannot be appropriately controlled by continuously applying a voltage having the same value, so that the electro-optical materials can be returned to a normal state.

However, if the common potential is changed in the period other than the blanking period, that is, the period in which the image signals are supplied to the pixel electrodes, a voltage corresponding to the pixel electrode potential is not applied to the electro-optical materials. As a result, defects may occur in an image to be displayed.

Hence, in the invention, in particular, the common potential is changed in the blanking period as described above. In other words, the common potential is changed in the period that does not contribute to image display. Thus, the display defects can be effectively reduced without causing defects in an image to be displayed. Typically, such an effect is significantly enhanced when the common potential is changed many times (e.g., like an alternating current). However, even if the common potential is changed once, the display defects can be reduced to a visually-recognizable extent. Further, even if the predetermined period in which the potential different from the predetermined potential is maintained is an extremely short period (e.g., several hundreds of n seconds or a period shorted than this), the same effect can be sufficiently obtained.

Further, typically, the common potential is supplied as a constant potential in the period other than the blanking period. However, a swing width may exist therein to some extent or the common potential may be intentionally changed as in the case of common swing driving. That is, the above-described effect of the invention is obtained by changing the common potential in the blanking period, regardless of the state of the common potential in period other than the blanking period.

As described above, according to the driving circuit of the invention, the common potential is changed in the blanking period, so that the display defects can be effectively reduced. Consequently, in the electro-optical apparatus, a high quality image can be displayed.

According to the driving circuit of one embodiment of the invention, the common potential control unit changes the common potential such that the difference between the common potential and the image signal is increased.

According to the embodiment, the common potential is changed in the blanking period such that the difference between the common potential and the image signal (in more detail, the potential of the pixel electrode having the image signal supplied thereto) is increased. Thus, when the common potential has been changed, the electric field generated between the pixel electrodes and the opposite electrode is increased. Consequently, the common potential is changed, so that force of the electric field exerted on the electro-optical materials is also increased, thereby enabling the display effects to be extremely and effectively reduced. As a result, in the electro-optical apparatus, a higher quality image can be displayed.

According to the embodiment in which the common potential is changed such that the difference between the common potential and the image signal is increased, a determination signal supply unit, which supplies the common potential control unit with a determination signal for determining the polarity of the image signal, is further provided, and the common potential control unit may be configured to change the common potential based on the determination signal.

With such a configuration, the common potential control unit can determine the polarity of the image signal by the determination signal supplied from the determination signal supply unit. Thus, the polarity of the pixel electrode potential can be determined. If the common potential control unit changes the common potential such that the common potential has a polarity reverse to the polarity of the image signal, the difference between the pixel electrode potential and the common potential can be reliably increased. Consequently, the display effects can be extremely and simply reduced.

According to the driving circuit of another embodiment of the invention, a precharge potential supply unit, which supplies the pixel electrodes with a precharge potential prior to the image signal, is further provided, and the common potential control unit changes the common potential at the timing at which the precharge potential is supplied to the pixel electrodes.

According to the embodiment, the precharge potential is supplied to the pixel electrodes from the precharge potential supply unit. Since the precharge potential corresponds to the image signal and enhances the quality of image writing by the image signal, the precharge potential is supplied to the pixel electrodes prior to the image signal.

According to the embodiment, in particular, the common potential is changed at the timing at which the above-described precharge potential is supplied to the pixel electrodes. In this way, the common potential can be reliably changed in the blanking period. In addition, the precharge potential supply unit is allowed to synchronize with the common potential control unit, so that the circuit configuration can be prevented from being highly complicated. Consequently, the display effects can be effectively reduced.

According to the driving circuit of a further embodiment of the invention, a selection signal output unit, which outputs a selection signal for defining a period for which the image signal is supplied to the pixel electrodes, is further provided, and the common potential control unit changes the common potential based on the selection signal.

According to the embodiment, the selection signal, which defines the period for which the image signal is supplied to the pixel electrodes, is output from the selection signal output unit. The selection signal, for example, is transmitted to each pixel through scanning lines intersecting data lines through which the image signal is transferred.

According to the embodiment, in particular, the common potential is changed based on the above-described selection signal. In detail, the period for which the image signal is supplied to the pixel electrodes can be understood by the selection signal, so that the common potential can be reliably changed in the blanking period. In addition, the selection signal output unit is allowed to synchronize with the common potential control unit, so that the circuit configuration can be prevented from being highly complicated. Consequently, the display effects can be effectively reduced.

According to another aspect of the invention, there is provided a driving method of driving an electro-optical apparatus including electro-optical materials interposed between a pixel electrode and an opposite electrode which face each other, the driving circuit including: supplying an image signal, which corresponds to an image to be displayed, to the pixel electrode; supplying a common potential, which is a predetermined potential, to the opposite electrode; and during a period for which the image signal is not supplied to the pixel electrode, controlling the common potential supply unit such that the common potential is changed to a potential different from the predetermined potential and maintained for a predetermined period, and then the common potential is returned again to the predetermined potential.

According to the driving method of the invention, similarly to the above-described driving circuit of the invention, the common potential is changed in the blanking period, so that the display defects can be effectively reduced. Consequently, in the electro-optical apparatus, a high quality image can be displayed.

Further, even in the driving method of the invention, various embodiments being the same as those of the above-described driving circuit of the invention can be employed.

In order to solve the problems, the electro-optical apparatus of the invention is provided with the above-described driving circuit of the invention as well as various embodiments thereof.

According to the electro-optical apparatus of the invention, the above-described driving circuit according to the invention is provided, so that the display defects can be reduced. Consequently, it is possible to display a high quality image.

Further, for example, the electro-optical apparatus of the invention is formed by interposing the electro-optical materials between a device substrate including pixel electrodes and an opposite substrate including an opposite electrode. Typically, the above-described driving circuit is provided on the device substrate. However, the driving circuit may be provided on another substrate (e.g., a flexible substrate) connected to the device substrate.

In order to solve the problems, the electronic apparatus of the invention is provided with the above-described electro-optical apparatus of the invention.

According to the electronic apparatus of the invention, the above-described electro-optical apparatus of the invention is provided. Consequently, various electronic apparatuses capable of displaying a high quality image, such as projection type display apparatuses, televisions, cellular phones, electronic pocket books, word processors, view finder type or monitor direct view-type video tape recorders, work stations, television phones, POS terminals or touch panels, can be realized. Further, for example, an electrophoresis apparatus such as an electronic paper can also be realized as the electronic apparatus of the invention.

Operations and other advantages of the invention will become apparent from the below-described embodiment of the invention.

### BRIEF DESCRIPTION OF THE DRAWINGS

The invention will be described with reference to the accompanying drawings, wherein like numbers reference like elements.

FIG. 1 is a plan view illustrating the configuration of an electro-optical apparatus according to an embodiment.

FIG. 2 is a sectional view taken along II-II of FIG. 1.

FIG. 3 is an equivalent circuit of various devices, interconnections or the like in a plurality of pixels formed in a matrix shape and constituting an image display area of an electro-optical apparatus according to an embodiment.

FIG. 4 is a perspective view illustrating the connection of an electro-optical apparatus according to an embodiment.

FIG. 5 is a block diagram schematically illustrating the configuration of a driving circuit according to a first embodiment.

FIG. 6 is a timing chart illustrating various signals output from a driving circuit according to a first embodiment.

FIG. 7 is a wave system diagram illustrating a modified example for the control of a common potential.

FIG. 8 is a block diagram schematically illustrating the configuration of a driving circuit according to a second embodiment.

FIG. 9 is a timing chart illustrating various signals output from a driving circuit according to a second embodiment.

FIG. 10 is a block diagram schematically illustrating the configuration of a driving circuit according to a third embodiment.

FIG. 11 is a timing chart illustrating various signals output from a driving circuit according to a third embodiment.

FIG. 12 is a plan view illustrating a configuration example of a projector as one example of an electronic apparatus employing an electro-optical apparatus.

### DESCRIPTION OF EXEMPLARY EMBODIMENTS

Hereinafter, an embodiment of the invention will be described with reference to the accompanying drawings.

### Electro-Optical Apparatus

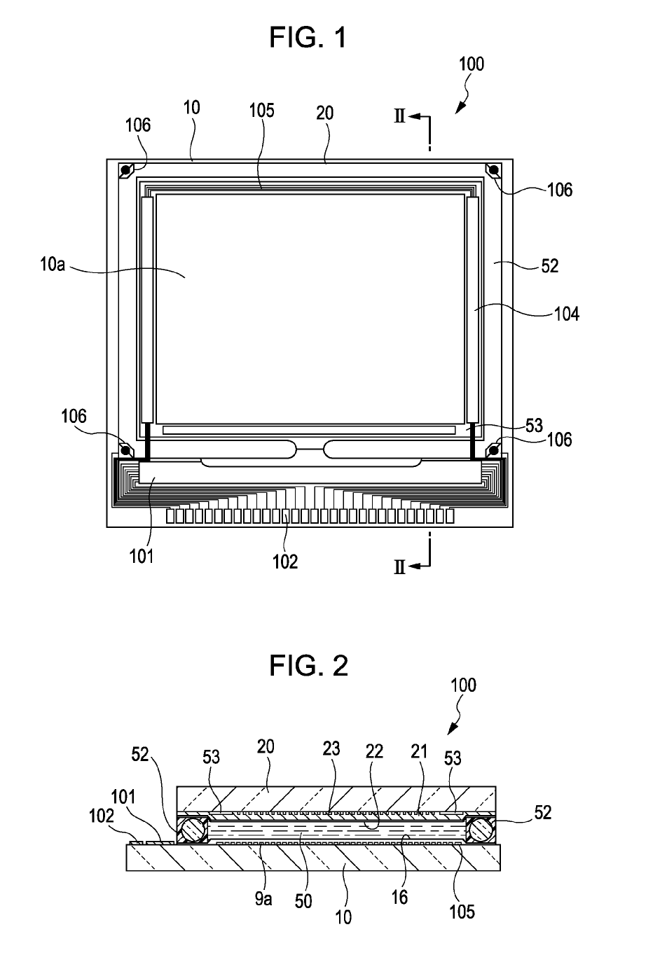

First, the configuration of the electro-optical apparatus according to the embodiment of the invention will be described with reference to FIGS. 1 and 2. FIG. 1 is a plan view illustrating the entire configuration of the electro-optical apparatus according to the embodiment, and FIG. 2 is a sectional view taken along II-II of FIG. 1. In the embodiment below, a TFT (Thin Film Transistor) active matrix driving type liquid crystal apparatus having a driving circuit therein, which is one example of the electro-optical apparatus of the invention, will be described as an example.

Referring to FIGS. 1 and 2, in the electro-optical apparatus 100 according to the embodiment, a TFT array substrate 10 and an opposite substrate 20 are disposed while facing each other. The TFT array substrate 10, for example, includes a transparent substrate such as a quartz substrate and a glass substrate, a silicon substrate or the like. The opposite substrate 20, for example, includes a transparent substrate such as a quartz substrate and a glass substrate. A liquid crystal layer 50, which is one example of the electro-optical apparatus of the invention, is encapsulated between the TFT array substrate 10 and the opposite substrate 20. The liquid crystal layer 50, for example, includes liquid crystals in which one type or several types of nematic liquid crystals are mixed, and has a predetermined alignment state between one pair of alignment layers.

The TFT array substrate 10 and the opposite substrate 20 adhere to each other by seal member 52 provided in a seal area located in the periphery of an image display area 10a in which a plurality of pixel electrodes are installed.

In order to adhere both the substrates to each other, the seal member 52, for example, is made of ultraviolet curing resin, thermosetting resin or the like. According to the manufacturing process, the seal member 52 is coated on the TFT array substrate 10, and then cured by ultraviolet irradiation, heating, or the like. Gap members such as glass fibers or glass beads are scattered in the seal member 52 to maintain a gap (i.e., an inter-substrate gap) between the TFT array substrate 10 and the opposite substrate 20 at a predetermined value. Alternatively, the gap members may be with mixture with the seal member 52, or disposed in the image display area 10a or the peripheral area around the image display area 10a.

A frame light shielding film 53, which is disposed in parallel inside the seal area where the seal member 52 is disposed and defines a frame area of the image display area 10a, is provided in the opposite substrate 20. Further, a part or the whole of the frame light shielding film 53 may be provided in the TFT array substrate 10 as an embedded light shielding film.

In a peripheral area outside the seal area where the seal member 52 is disposed, a data line driving circuit 101 and external circuit connecting terminals 102 are provided along one side of the TFT array substrate 10. Scanning line driving circuits 104 are provided along two sides adjacent to one side of the TFT array substrate 10 so as to be covered with the frame light shielding film 53. In addition, in order to interconnect the two scanning line driving circuits 104 provided at both sides of the image display area 10a, a plurality of interconnections 105 are provided along the other side of the TFT array substrate 10 so as to be covered with the frame light shielding film 53.

On the TFT array substrate 10, vertical conductive terminals 106 are disposed at areas, which face four corners of the opposite substrate 20, to interconnect both the substrates through vertical conductive members 107. With such a configuration, the TFT array substrate 10 and the opposite substrate 20 can be electrically connected to each other.

In FIG. 2, on the TFT array substrate 10, there is formed a laminated structure in which pixel switching TFTs serving as driving elements or interconnections such as scanning lines and data lines are formed. The detailed configuration of the laminated structure is not illustrated in FIG. 2. However, pixel electrodes 9a made of transparent material such as ITO (Indium Tin Oxide) are formed for each pixel on the laminated structure so as to have an island shape with a predetermined pattern.

The pixel electrodes 9a are formed in the image display area 10a on the TFT array substrate 10 to face the opposite electrode 21. An alignment layer 16 is formed on a surface of the TFT array substrate 10, which faces the liquid crystal layer 50, that is, the alignment layer 16 is formed on the pixel electrodes 9a to cover the pixel electrodes 9a.

A light shielding film 23 is formed on a surface of the opposite substrate 20, which faces the TFT array substrate 10. The light shielding film 23, for example, is formed on the surface of the opposite substrate 20 in a lattice shape when seen in a plan view. On the opposite substrate 20, a non-opening area is defined by the light shielding film 23, and an area marked by the light shielding film 23 serves as an opening area where light emitted from a lamp or a direct view type backlight for a projector is penetrated. Alternatively, after the light shielding film 23 is formed in a strip shape, the non-opening area may be defined by the light shielding film 23 and various elements such as data lines provided in the TFT array substrate 10.

An opposite electrode 21 made of transparent material such as ITO is formed on the light shielding film 23 to face the pixel electrodes 9a. Further, on the light shielding film 23, in order to perform color display in the image display area 10a, color filters (not illustrated in FIG. 2) may be formed in an area including the opening area and a part of the non-opening area. An alignment layer 22 is formed on the surface of the opposite substrate 20, which faces the TFT array substrate 10, that is, the alignment layer 22 is formed on the opposite electrode 21.

Further, on the TFT array substrate 10 as illustrated in FIGS. 1 and 2, there may formed a sampling circuit that samples an image signal on an image signal line to supply a sampled signal to the data lines, a precharge circuit that supplies the data lines with a precharge signal having a predetermined voltage level prior to the image signal, an inspection circuit that inspects the quality, defects, or the like of the electro-optical apparatus 100 during the manufacturing and in shipment thereof, or the like, in addition to the driving circuit such as the above-described data line driving circuit 101 and the scanning line driving circuits 104.

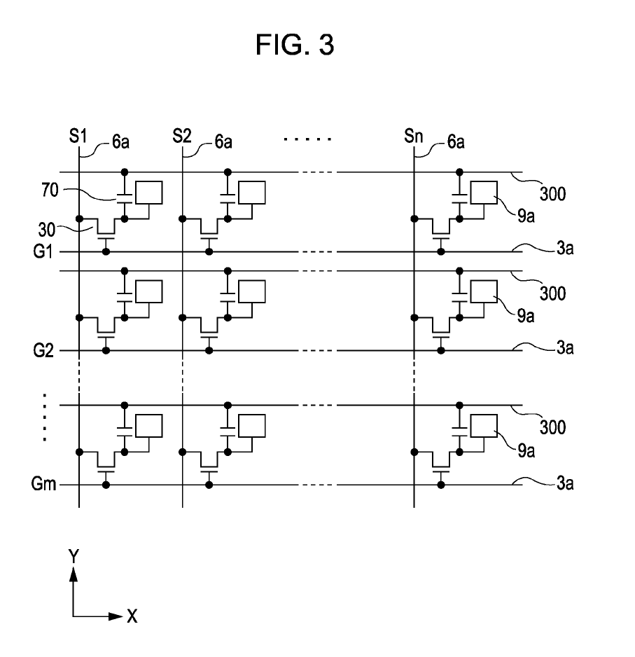

Hereinafter, the electrical configuration of a pixel unit of the electro-optical apparatus according to the embodiment will be described with reference to FIG. 3. FIG. 3 is an equivalent circuit of various devices, interconnections or the like in a plurality of pixels formed in a matrix shape and constituting the image display area of the electro-optical apparatus according to the embodiment.

In FIG. 3, the pixel electrodes 9a and TFTs 30 are formed for the pixels formed in the matrix shape and constituting the image display area 10a, respectively. The TFT 30 is electrically connected to the pixel electrode 9a, and switches the pixel electrode 9a when the electro-optical apparatus 100 according to the embodiment operates. Data lines 6a to which the image signal is supplied are electrically connected to sources of the TFTs 30, respectively. Image signals S1, S2, . . . , Sn written on the data lines 6a may be supplied in line sequence while maintaining the arrangement state. Further, the image signals S1, S2, . . . , Sn may also be supplied to each group of the data lines 6a adjacent to each other.

Scanning lines 3a are electrically connected to gates of the TFTs 30, respectively. The apparatus 100 according to the embodiment is configured to apply scanning signals G1, G2, . . . , Gm in the form of pulses to the scanning lines 3a in line sequence at a predetermined timing while maintaining the arrangement state thereof. The pixel electrodes 9a are electrically connected to drains of the TFTs 30, respectively. The TFTs 30 serving as a switching device are turned off for a predetermined period, so that the image signals S1, S2, . . . , Sn supplied from the data lines 6a are written at a predetermined timing. The image signals S1, S2, . . . , Sn having a predetermined level, which are written in the liquid crystals (one example of electro-optical materials) via the pixel electrodes 9a, are held between the pixel electrodes 9a and the opposite electrode 21 formed on the opposite substrate 20 for a predetermined period.

In relation to the liquid crystals constituting the liquid crystal layer 50 (see FIG. 2), alignment and order of a molecular aggregate thereof vary depending on the level of an applied voltage, so that light can be modulated and gradation display can be performed. For example, in a normally white mode, transmittance for an incident light is reduced in response to voltages applied in pixel units. In a normally black mode, the transmittance for the incident light is reduced in response to the voltages applied in pixel units. As a whole, a light having contrast corresponding to image signals is emitted from an electro-optical apparatus.

In order to prevent leakage of the image signals being held, a storage capacitor 70 is provided in parallel to a liquid crystal capacitor formed between the pixel electrodes 9a and the opposite electrode 21 (see FIG. 2). The storage capacitor 70 is a capacitive element functioning as a holding capacitor that temporarily holds potentials of each pixel electrode 9a in response to the supply of the image signals. One of electrodes of the storage capacitor 70 is in parallel to the pixel electrode 9a while being electrically connected to the drain of the TFT 30, and the other electrode of the storage capacitor 70 is electrically connected to a capacitance line 300 of which the potential is fixed so as to be applied with a constant potential. The storage capacitor 70 is provided, so that potential holding characteristics in the pixel electrode 9a can be improved, and display characteristics can be improved through improvement of contrast and reduction of flicker.

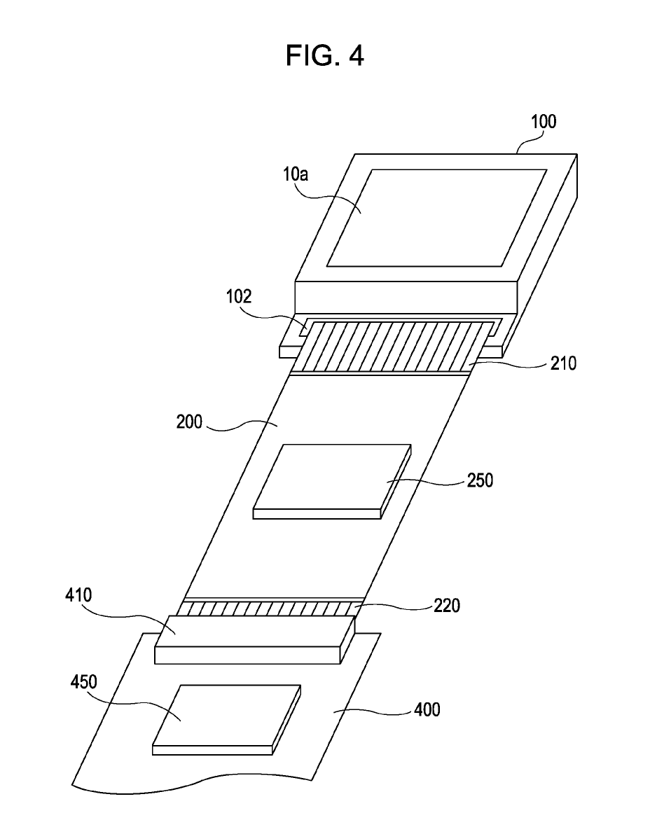

Hereinafter, the connection of the electro-optical apparatus according to the embodiment will be described with reference to FIG. 4. FIG. 4 is a perspective view illustrating the connection of the electro-optical apparatus according to the embodiment. In FIG. 4, detailed members constituting the electro-optical apparatus as shown in FIGS. 1 and 2 are duly omitted.

In FIG. 4, for example, when the electro-optical apparatus 100 according to the embodiment is mounted on an electronic apparatus such as a projector, the electro-optical apparatus 100 is electrically connected to a circuit board 400 via a flexible board 200.

The flexible board 200 is provided at both ends thereof with connection terminals 210 and 220. The connection terminal 210 is electrically connected to an external circuit connection terminal 102 of the electro-optical apparatus 100. Further, the connection terminal 220 is electrically connected to a connector 410 of the circuit board 400.

In addition, the flexible board 200 is provided thereon with a first integrated circuit 250. The first integrated circuit 250 is constructed as a driving circuit of the electro-optical apparatus 100. For example, the first integrated circuit 250 performs various correction and conversion processes with respect to an image signal input to the flexible board 200, and outputs the process result. Further, the first integrated circuit 250 may include the data line driving circuit 101, the scanning line driving circuits 104 or the like, which are embedded in the above-described electro-optical apparatus 100.

The circuit board 400 is provided thereon with a second integrated circuit 450. Similarly to the first integrated circuit 250, the second integrated circuit 450 performs various correction and conversion processes with respect to an image signal input to the flexible board 200, and outputs the process result. Further, a driving circuit according to the embodiment which will be described later, for example, is configured as a part or the whole of the first integrated circuit 250 and the second integrated circuit 450. Alternatively, the driving circuit according to the embodiment may be provided on the TFT array substrate 10 similarly to the data line driving circuit 101, the scanning line driving circuits 104, or the like, as shown in FIGS. 1 and 2.

The special driving performed by the electro-optical apparatus according to the embodiment will be described together with the configuration of a driving circuit and a driving method below.

### Driving Circuit and Driving Method

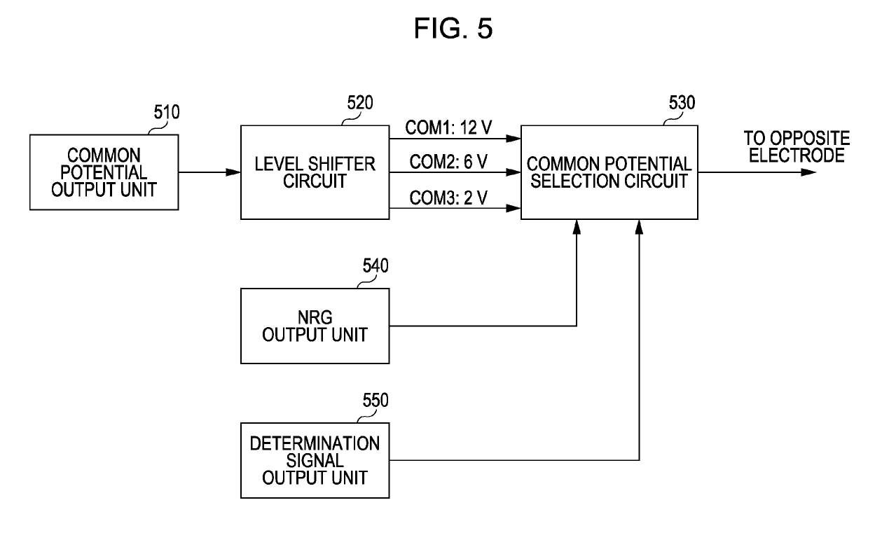

Next, the driving circuit and the driving method according to the embodiment will be described with reference to FIGS. 5 to 11. In the following description, three types of embodiments in which driving methods are partially different from each other will be given as examples.

### First Embodiment

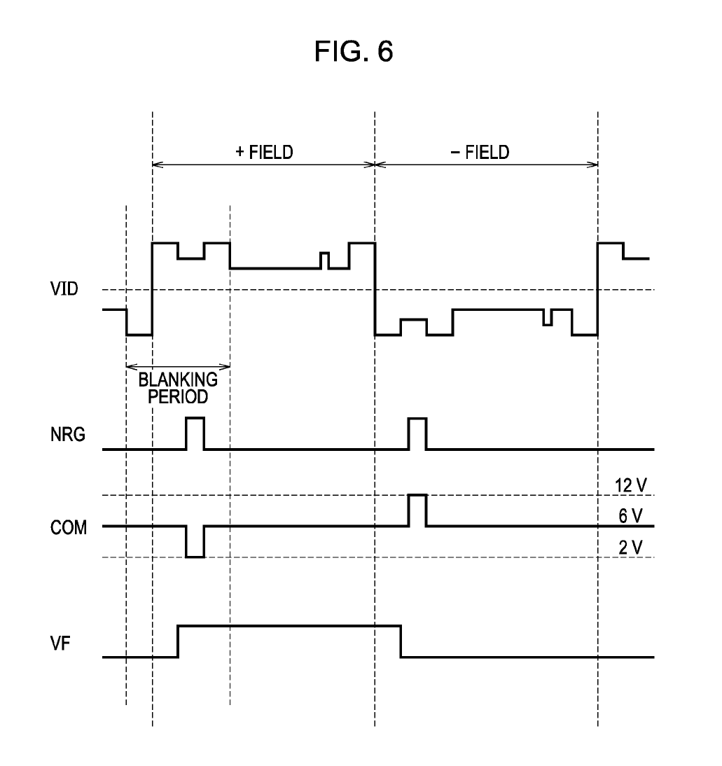

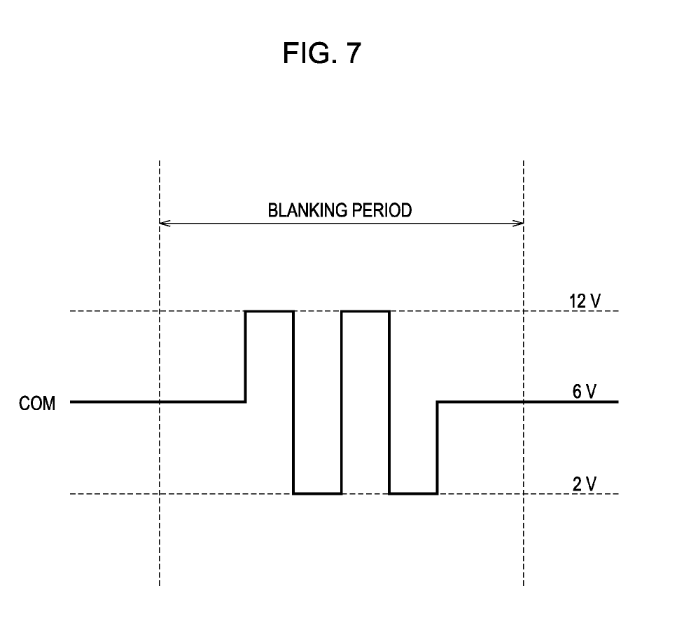

First, the driving circuit and the driving method according to the first embodiment will be described with reference to FIGS. 5 to 7. FIG. 5 is a block diagram schematically illustrating the configuration of the driving circuit according to the first embodiment, and FIG. 6 is a timing chart illustrating various signals output from the driving circuit according to the first embodiment. Further, FIG. 7 is a wave system diagram illustrating a modified example for the control of a common potential.

In FIG. 5, the driving circuit according to the first embodiment includes a common potential output unit 510, a level shifter circuit 520, a common potential selection circuit 530, an NRG output unit 540 and a determination signal output unit 550.

The common potential output unit 510 outputs a potential, which is supplied from outside the driving circuit as a power supply potential, to the level shifter circuit 520 as a potential for a common potential COM.

The level shifter circuit 520 increases or reduces the potential, which is supplied from the common potential output unit 510, to generate three common potentials COM1 (12 V), COM2 (6 V) and COM3 (2 V), and outputs the three common potentials to the common potential selection circuit 530.

The common potential selection circuit 530 selects one of the three common potentials COM1 (12 V), COM2 (6 V) and COM3 (2 V) which are supplied from the level shifter circuit 520, and outputs the selected potential to the opposite electrode 21 (see FIG. 2).

Further, the common potential output unit 510, the level shifter circuit 520 and the common potential selection circuit 530 as described above are formed as one example of “a common potential supply section” and “a common potential control section” of the invention.

The NRG output unit 540 outputs a signal NRG that defines a timing at which a precharge potential is supplied. The signal NRG is input to an OR circuit together with a signal from a shift register in the data line driving circuit 101 (see FIG. 1). When the signal NRG has a high level, a sampling transistor of the data line driving circuit 101 is turned on. The NRG output unit 540 outputs the signal NRG to the common potential selection circuit 530 as well as the above-described OR circuit.

The determination signal output unit 550 is one example of a “determination signal supply section” of the invention, and outputs a signal VF, which is used to determine the polarity of an image signal VID for displaying an image, to the common potential selection circuit 530.

As shown in FIG. 6, for example, the image signal VID is supplied such that “+field” (i.e., a period in which the polarity is positive) and “−field” (i.e., a period in which the polarity is negative) are repeated. In such a case, the signal NRG that defines the timing at which the precharge potential is supplied in a blanking period in which the image signal VID is not supplied to the pixel electrodes 9a.

According to the first embodiment, in particular, the common potential COM, which is maintained at a constant state when image writing is performed, is temporarily changed in synchronization with the signal NRG in the blanking period. In addition, such a change in the potential of the common potential COM is determined based on the polarity of the image signal VID when the change starts.

In detail, first, the common potential selection circuit 530 selects and outputs the common potential COM2 (6 V) as the common potential COM in the period (i.e., other than the blanking period) in which the image signal VID is supplied to the pixel electrodes 9a and a period in which the signal NRG has a low level in the blanking period. Next, the common potential selection circuit 530 selects and outputs the common potential COM3 (2 V) as the common potential COM in the period in which the signal NRG has a high level in the “+field”. Last, the common potential selection circuit 530 selects and outputs the common potential COM1 (12 V) as the common potential COM in the period in which the signal NRG has a high level in the “−field”. Further, the common potential selection circuit 530 determines the polarity of the image signal VID based on the signal VF output from the determination signal output unit 550.

As described above, the common potential COM is temporarily changed, so that an electric field between the pixel electrodes 9a and the opposite electrode 21 can be temporarily changed. Thus, for example, display defects caused by a transverse electric field can be effectively prevented. That is, a voltage having a different value is temporarily applied to the liquid crystal layer 50, so that liquid crystal molecules, which cannot be appropriately controlled by continuously applying a voltage having the same value, can be returned to a normal state.

However, if the common potential COM is changed in the period other than the blanking period, a voltage corresponding to the image signal is not applied to the liquid crystal layer 50. As a result, defects may occur in an image to be displayed.

In order to prevent such a problem, according to the driving circuit of the first embodiment, the common potential COM is changed in the blanking period. In other words, the common potential COM is changed in the period that does not contribute to image display. Thus, the display defects can be effectively reduced without causing defects in an image to be displayed. Further, such an operation is performed by the synchronization between the common potential selection circuit 530 and the NRG output unit 540. Therefore, the above-described beneficial effects can be achieved by such an extremely simple configuration. Herein, the period in which the common potential COM is changed may not completely coincide with the period in which the pulse of the signal NRG is supplied. That is, so long as the common potential COM is changed in the blanking period, the common potential COM may be changed in a long period or a short period as compared with the signal NRG.

In addition, according to the driving circuit of the first embodiment, the common potential COM is changed in response to the polarity of the image signal VID when the change starts. In detail, the common potential COM is changed to have a small value in the “+field” and a large value in the “−field”. That is, the common potential COM is changed such that the difference between the common potential COM and the image signal VID is increased. In this way, when the common potential COM is changed, a higher voltage is applied to the liquid crystal layer 50. Consequently, the liquid crystal molecules are stimulated, so that a significant effect of reducing the display defects can be obtained.

In FIG. 7, change of the common potential COM in one blanking period may occur in several times. In other words, the pulse width and timing of the signal NRG and the pulse width and timing of the common potential COM may not completely coincide with each other. In detail, as shown in FIG. 7, for example, the common potentials COM1 (12 V) and COM3 (2 V) are selected such that they are repeated at an interval of 100 nsec, so that a stronger stimulation can be applied to the liquid crystal molecules in the liquid crystal layer 50. In this way, the effect of reducing the display defects can be further increased.

As described above, according to the driving circuit and the driving method of the first embodiment, the common potential COM is changed in the blanking period, so that the display defects can be reduced. Consequently, a high quality image can be displayed on the electro-optical apparatus 100.

### Second Embodiment

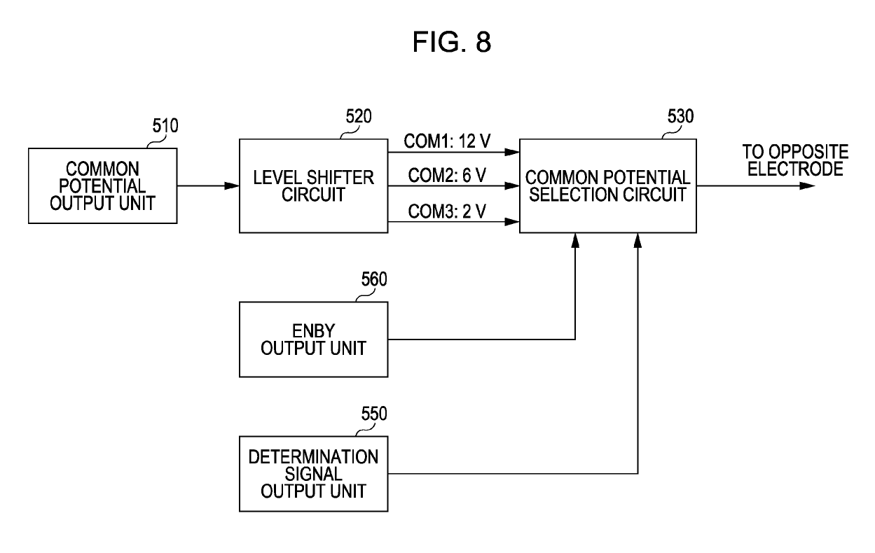

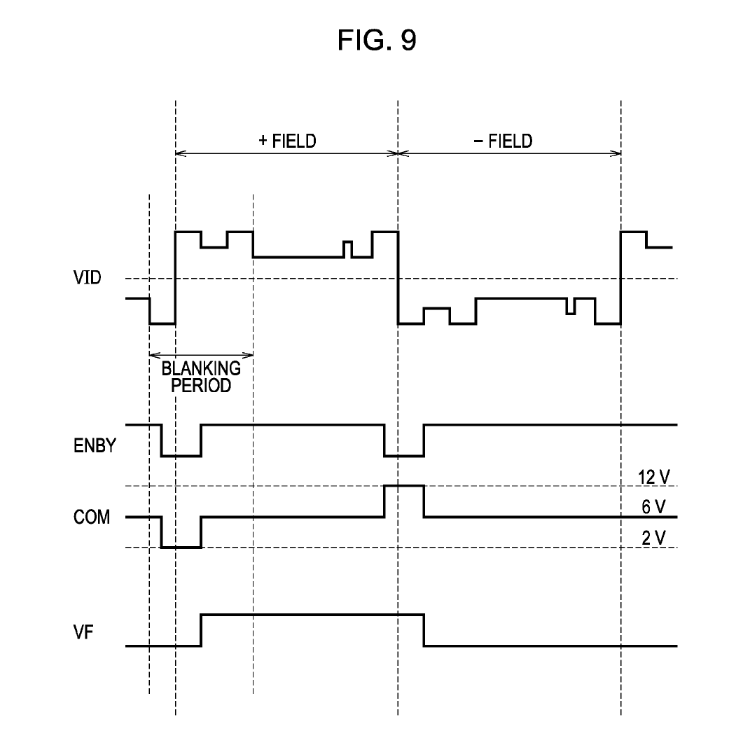

Next, the driving circuit and the driving method according to the second embodiment will be described with reference to FIGS. 8 and 9. FIG. 8 is a block diagram schematically illustrating the configuration of the driving circuit according to the second embodiment, and FIG. 9 is a timing chart illustrating various signals output from the driving circuit according to the second embodiment. The configuration and operation of the second embodiment is substantially identical to the first embodiment, except that a timing at which the common potential is changed is different from that of the first embodiment. Thus, the second embodiment will be described while focusing on the difference relative to that of the first embodiment, and description of elements the same as those of the first embodiment will be omitted.

In FIG. 8, the driving circuit according to the second embodiment includes the common potential output unit 510, the level shifter circuit 520, the common potential selection circuit 530, the determination signal output unit 550 and an ENBY output unit 560. That is, in the driving circuit according to the second embodiment, the NRG output unit 540 provided in the driving circuit according to the first embodiment is replaced with the ENBY output unit 560.

The ENBY output unit 560 outputs a signal ENBY that defines a period in which the image signal VID is supplied to the pixel electrode 9a. The signal ENBY is input to an AND circuit together with a signal from a shift register in the scanning line driving circuit 104 (see FIG. 1), and the pulse width of a scanning signal output to the scanning line 3a is defined based on the signal ENBY. The ENBY output unit 560 outputs the signal ENBY to the common potential selection circuit 530 as well as the above-described AND circuit.

In FIG. 9, in the driving circuit according to the second embodiment, in particular, the common potential COM is temporarily changed in synchronization with the signal ENBY. In detail, the common potential selection circuit 530 selects and outputs the common potential COM2 (6 V) as the common potential COM in the period (i.e., other than the blanking period) in which the image signal VID is supplied to the pixel electrodes 9a and a period in which the signal ENBY has a high level in the blanking period. Next, the common potential selection circuit 530 selects and outputs the common potential COM3 (2 V) as the common potential COM in the period in which the signal ENBY has a low level in the “+field”. Last, the common potential selection circuit 530 selects and outputs the common potential COM1 (12 V) as the common potential COM in the period in which the signal ENBY has a low level in the “−field”.

As described above, the common potential COM is changed, so that the display defects can be effectively reduced without causing defects in an image to be displayed. Such an operation is performed by the synchronization between the common potential selection circuit 530 and the ENBY output unit 560. Therefore, the above-described beneficial effects can be achieved by such an extremely simple configuration. Herein, the period in which the common potential COM is changed may not completely coincide with the period in which the signal ENBY has a low level supplied. That is, so long as the common potential COM is changed in the blanking period, the common potential COM may be changed in a long period or a short period as compared with the signal ENBY.

In addition, differently from the signal NRG, the signal ENBY is output up to just before the determination signal VF is switched. Thus, according to the driving circuit of the second embodiment, the common potential COM is changed to have the same polarity as that of the determination signal VF, differently from the first embodiment.

As described above, according to the driving circuit and the driving method of the second embodiment, the display defects can be effectively reduced, similarly to the first embodiment. Consequently, a high quality image can be displayed on the electro-optical apparatus 100.

### Third Embodiment

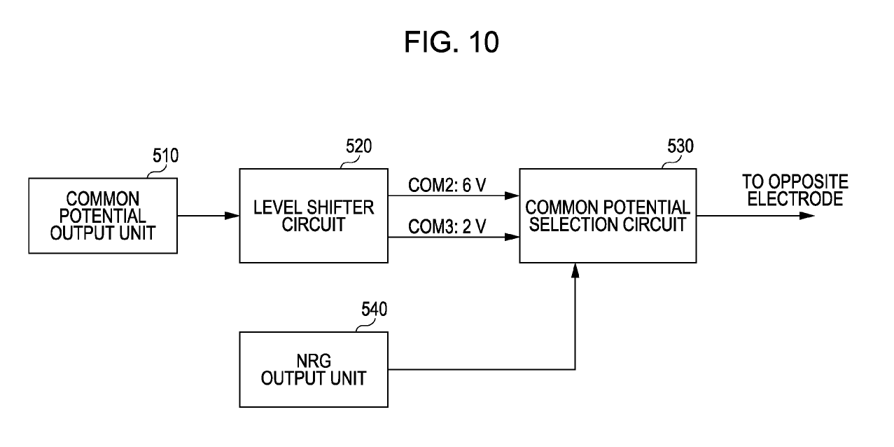

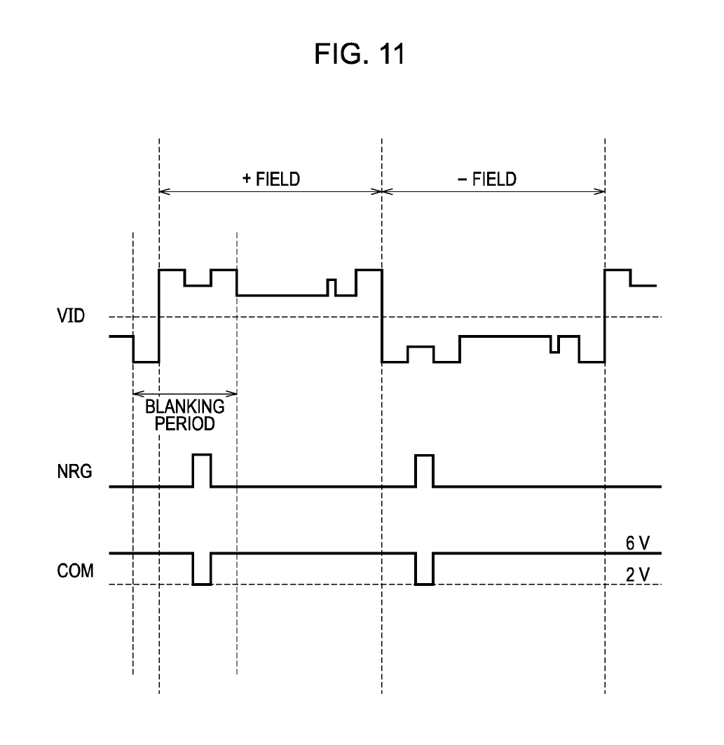

Last, the driving circuit and the driving method according to the third embodiment will be described with reference to FIGS. 10 and 11. FIG. 10 is a block diagram schematically illustrating the configuration of the driving circuit according to the third embodiment, and FIG. 11 is a timing chart illustrating various signals output from the driving circuit according to the third embodiment. The configuration and operation of the third embodiment is substantially identical to the first embodiment, except that the value of the common potential is different from that of the first embodiment. Thus, the third embodiment will be described while focusing on the difference relative to that of the first embodiment, and description of elements which are the same as those of the first embodiment will be omitted.

In FIG. 10, the driving circuit according to the third embodiment includes the common potential output unit 510, the level shifter circuit 520, the common potential selection circuit 530 and the NRG output unit 540. That is, the driving circuit according to the third embodiment is not provided with the determination signal output unit 550, differently from the driving circuit according to the first embodiment and the driving circuit according to the second embodiment (see FIGS. 5 and 8). Further, the level shifter circuit 520 is configured to output two types of potentials COM2 and COM3.

In FIG. 11, in the driving circuit according to the third embodiment, when the signal NRG has a high level, the common potential COM is changed from the COM2 (6 V) to the COM3 (2 V). That is, in the third embodiment, the common potential COM is changed regardless of the polarity of the image signal, differently from the first embodiment and the second embodiment.

In such a case, in the “−field”, the common potential COM is changed such that the difference between the common potential COM and the image signal VID is reduced. However, according to the research of an inventor of the invention, the effect of reducing the display defects is significantly enhanced in the “+field” as compared with the “−field”. Consequently, although the common potential COM is not changed between two values, the display defects can be efficiently reduced.

According to the third embodiment, in particular, since the polarity of the image signal VID is not determined, the circuit configuration can be simplified.

As described above, according to the driving circuit and the driving method of the third embodiment, the circuit configuration can be prevented from being complicated and the display defects can be significantly reduced.

### Electronic Apparatus

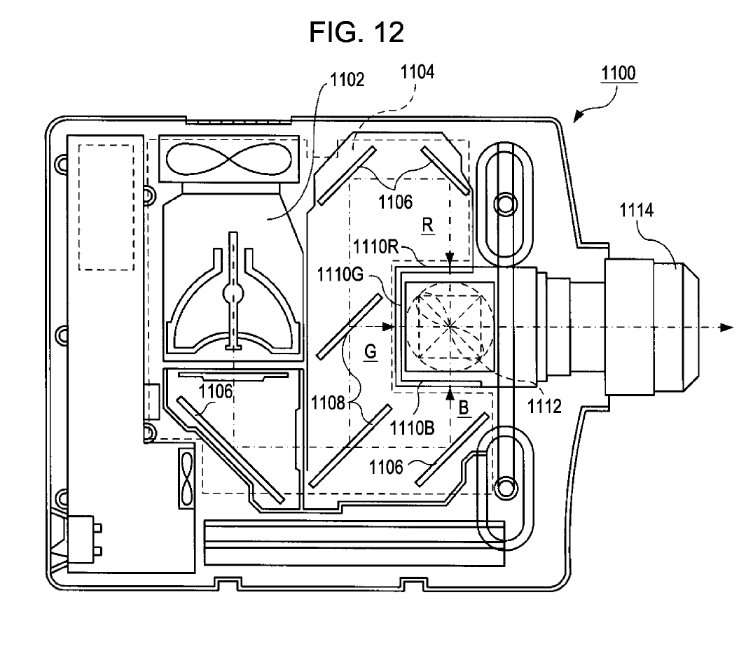

Next, a case in which the liquid crystal apparatus as the above-described electro-optical apparatus is applied to various electronic apparatuses will be described. FIG. 12 is a plan view illustrating a configuration example of a projector. Hereinafter, the projector using the liquid crystal apparatus as a light value will be described.

As shown in FIG. 12, a lamp unit 1102 including a white light source such as a halogen lamp is provided inside the projector 1100. A projection light emitted from the lamp unit 1102 is divided into the three primary colors of R, G and B by four mirrors 1106 and two dichroic mirrors 1108 disposed inside a light guide 1104, and thereafter is incident on liquid crystal panels 1110R, 1110B and 1110G as light values corresponding to the three primary colors.

The configuration of the liquid crystal panels 1110R, 1110B and 1110G is the same as that of the above-described liquid crystal apparatus, and the liquid crystal panels 1110R, 1110B and 1110G are driven by the primary color signals of R, G and B supplied from an image signal processing circuit. Further, a light modulated by the liquid crystal panels is incident on a dichroic prism 1112 from three directions. In the dichroic prism 1112, the light of R and B is refracted at an angle of 90°, and the light of G goes straight. Accordingly, images of the respective colors are synthesized to be projected onto a screen or the like as color images through a projection lens 1114.

Herein, when noting images displayed by the liquid crystal panels 1110R, 1110B and 1110G, the image displayed by the liquid crystal panel 1110G is needed to be inverted horizontally with respect to the images displayed by the liquid crystal panels 1110R and 1110B.

Further, since lights corresponding to the primary color signals of R, G and B are incident on the liquid crystal panels 1110R, 1110B and 1110G by the dichroic mirrors 1108, it is not necessary to provide a color filter.

In addition to the electronic apparatus described with reference to FIG. 12, examples of the electronic apparatus include a mobile type personal computer, a cellular phone, a liquid crystal TV, a view finder type or monitor direct view-type video tape recorder, a car navigation apparatus, a pager, an electronic pocket book, a calculator, a word processor, a work station, a television phone, a POS terminal, an apparatus provided with a touch panel, or the like. Further, the liquid crystal apparatus can also be applied to such various electronic apparatuses.

In addition to the liquid crystal apparatus described in the above-described embodiments, the invention can be applied to a reflective liquid crystal apparatus (LCOS), a plasma display panel (PDP), a field emission display (FED, SED), an organic EL display, a digital micro-mirror device (DMD), an electrophoresis apparatus or the like.

The invention is not limited to the above-described embodiments, but may be appropriately modified in various forms without departing from the gist and spirit of the invention which can be understood from the appended claims and the whole specification. Therefore, it can be understood that a driving circuit, a driving method, an electro-optical apparatus and an electronic apparatus, which include such modifications, are included in the technical scope of the invention.

The entire disclosure of Japanese Patent Application No. 2009-027475, filed Feb. 9, 2009 is expressly incorporated by reference herein.

What is claimed is:

1. A driving circuit that drives an electro-optical apparatus including electro-optical materials interposed between a pixel electrode and an opposite electrode which face each other, the driving circuit comprising:
an image signal supply unit that supplies the pixel electrode with an image signal corresponding to an image to be displayed;
a common potential supply unit that supplies a common potential, which is a predetermined potential, to the opposite electrode; and
a common potential control unit that, during a period for which the image signal is not supplied to the pixel electrode, controls the common potential supply unit such that the common potential is changed to a potential different from the predetermined potential and maintained for a predetermined period, and then the common potential is returned again to the predetermined potential.

2. The driving circuit according to claim 1, wherein the common potential control unit changes the common potential such that a difference between potential of the pixel electrode and the common potential is increased.

3. The driving circuit according to claim 2, further comprising a determination signal supply unit that supplies the common potential control unit with a determination signal for determining a polarity of the image signal,
wherein the common potential control unit changes the common potential based on the determination signal.

4. The driving circuit according to claim 1, further comprising a precharge potential supply unit that supplies the pixel electrode with a precharge potential prior to the image signal,
wherein the common potential control unit changes the common potential at a timing at which the precharge potential is supplied to the pixel electrode.

5. The driving circuit according to claim 1, further comprising a selection signal output unit that outputs a selection signal for defining a period for which the image signal is supplied to the pixel electrode,
wherein the common potential control unit changes the common potential based on the selection signal.

6. An electro-optical apparatus comprising the driving circuit according to claim 1.

7. An electronic apparatus comprising the electro-optical apparatus according to claim 6.
